(19) United States
(12) Patent Application Publication
(10) Pub. No.: US 2017/0054818 A1
(43) Pub. Date: Feb. 23, 2017

(54) Preferred Network Information

(71) Applicant: Microsoft Technology Licensing, LLC, Redmond, WA (US)

(72) Inventors: Amer Aref Hassan, Kirkland, WA (US); Andrew Nicholas Paul Smith, London (GB)

(21) Appl. No.: 14/832,440

(22) Filed: Aug. 21, 2015

(51) Int. Cl. H04L 29/08; H04L 29/06

(52) U.S. Cl. CPC H04L 67/16; H04L 65/1069

(57) ABSTRACT

Techniques for preferred network information are described. According to various implementations, a cloud-based service maintains location-specific network information that identifies preferred networks at different locations. The network information is propagated to various devices to enable the devices to connect to a preferred network for communicating media data of communication sessions.

### BACKGROUND

Modern communication systems have an array of capabilities, including integration of various communication modalities with different services. For example, voice/video communications, instant messaging, data/application sharing, white-boarding, and other forms of communication may be combined with presence and availability information for users. Such systems enable users to engage in communication sessions to exchange different types of communication media, such as voice data, video data, content sharing, and combinations thereof. Furthermore, collaboration systems that enable users to share and collaborate in creating and modifying various types of documents and content may be integrated with multimodal communication systems providing different kinds of communication and collaboration capabilities. Such integrated systems are sometimes referred to as Unified Communication (UC) systems.

While UC systems provide for increased flexibility in communications, they also present a number of implementation challenges. For instance, determining optimal networks for transmitting UC data is difficult since devices involved in UC sessions are typically unaware of network attributes. Further, UC is typically implemented via software that can be loaded on mobile devices, e.g., tablets, smartphones, laptops, and so forth. Thus, techniques for managing UC communication traffic typically have to be fluid and dynamic to accommodate changing connection scenarios.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for preferred network information are described. According to various implementations, a cloud-based service maintains location-specific network information that identifies preferred networks at different locations. The network information is propagated to various devices to enable the devices to connect to a preferred network for communicating media data of communication sessions.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 depicts an example connectivity table in accordance with one or more embodiments.

FIG. 3 depicts an example implementation scenario for obtaining network information for a communication session in accordance with one or more embodiments.

FIG. 4 is a flow diagram that describes steps in a method for communicating network information in accordance with one or more embodiments.

FIG. 5 is a flow diagram that describes steps in a method for receiving network information in accordance with one or more embodiments.

FIG. 6 is a flow diagram that describes steps in a method for determining whether to perform a handover based on network information in accordance with one or more embodiments.

FIG. 7 is a flow diagram that describes steps in a method for selecting a network from a set of preferred networks in accordance with one or more embodiments.

FIG. 8 is a flow diagram that describes steps in a method for communicating updated network information in accordance with one or more embodiments.

FIG. 9 is a flow diagram that describes steps in a method for generating feedback for a data stream of a communication session in accordance with one or more embodiments.

FIG. 10 is a flow diagram that describes steps in a method for modifying network information in accordance with one or more embodiments.

FIG. 11 is a flow diagram that describes steps in a method for verifying network feedback in accordance with one or more embodiments.

FIG. 12 illustrates an example system and computing device as described with reference to FIG. 1, which are configured to implement embodiments of techniques described herein.

### DETAILED DESCRIPTION

### Overview

Techniques for preferred network information are described. According to various implementations, a cloud-based service maintains location-specific network information that identifies preferred networks at different locations. The preferred networks may be identified based on various parameters, such as device type, media type, encoding type, and so forth.

According to various implementations, network information is propagated from a cloud-based service to client devices that participate in communication sessions. The network information, for instance, identifies preferred networks at particular locations for transmitting data of a communication session. Generally, a communication session refers to an exchange of communication media between communication endpoints, such as a real-time communication session between users of different communication endpoints. Examples of a communication session include a Voice over Internet Protocol (VoIP) call, a video call, text messaging, a file transfer, and/or combinations thereof. A communication session, for instance, is typically implemented via Internet Protocol (IP). In at least some implementations, a communication session represents a Unified Communications (UC) session.

Accordingly, a client device that receives the network information utilizes the network information to identify and connect to a preferred network at a particular location. In at least some implementations, connecting to the preferred network overrides a default behavior of the client device. Thus, the client device may utilize the preferred network to transmit and receive data of a communication session.

Accordingly, implementations discussed herein provide for network-based propagation of network information to devices that participate in communication sessions. The network information can be used to ascertain a preferred network to be used for a communication session. Such network-based propagation of network information optimizes device and session performance by routing communication sessions over known high-quality networks. Thus, user experience during a communication session is enhanced. Further, allowing a network-based service to generate and propagate network information reduces processing load and battery usage on client devices that participate in communication sessions. For instance, a client device need not test network quality, but can rely on processing and storage capabilities of a network-based resource to identify preferred networks at a particular location.

In the following discussion, an example environment is first described that is operable to employ techniques described herein. Next, a section entitled “Example Implementation Scenario” describes an example implementation scenario in accordance with one or more embodiments. Following this, a section entitled “Example Procedures” describes some example procedures in accordance with one or more embodiments. Finally, a section entitled “Example System and Device” describes an example system and device that are operable to employ techniques discussed herein in accordance with one or more embodiments.

Having presented an overview of example implementations in accordance with one or more embodiments, consider now an example environment in which example implementations may by employed.

Example Environment

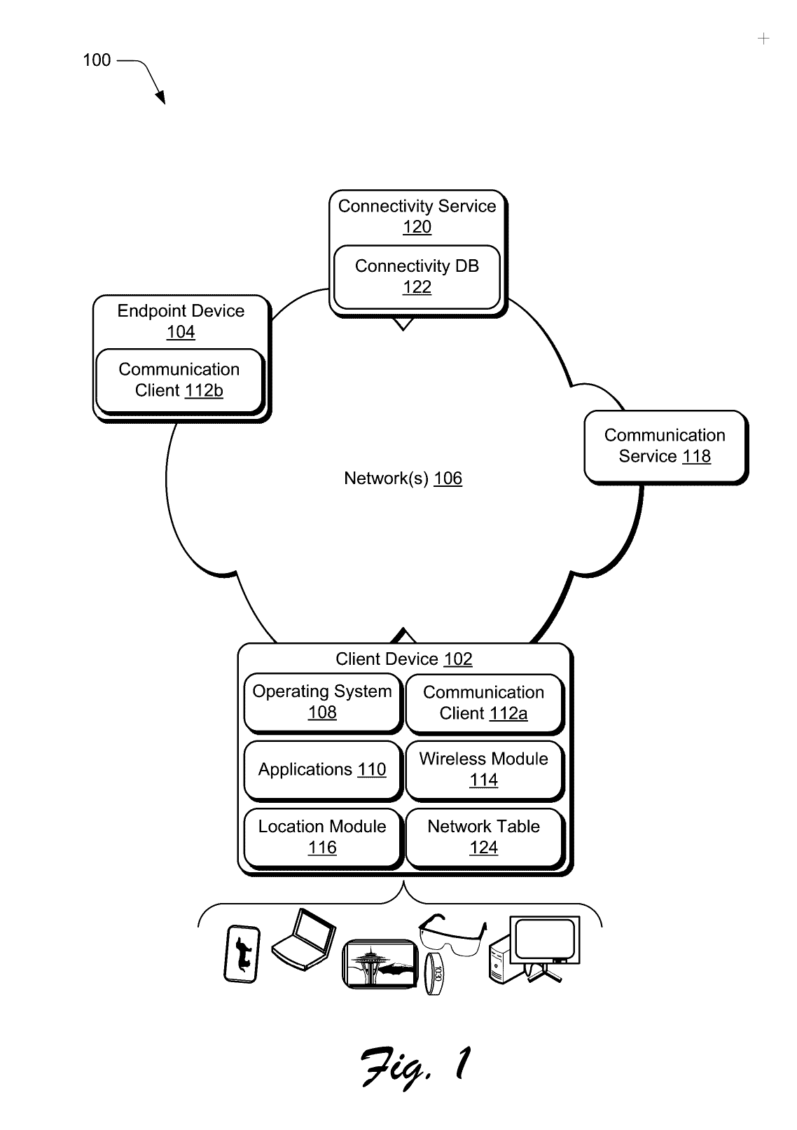

FIG. 1 is an illustration of an environment 100 in an example implementation that is operable to employ techniques preferred network information described herein. Generally, the environment 100 includes various devices, services, and networks that enable communication via a variety of different modalities. For instance, the environment 100 includes a client device 102 and an endpoint device 104 connected to a network 106. The client device 102 and the endpoint device 104 may be configured in a variety of ways, such as a traditional computer (e.g., a desktop personal computer, laptop computer, and so on), a mobile station, an entertainment appliance, a smartphone, a wearable device, a netbook, a game console, a handheld device (e.g., a tablet), and so forth.

The network 106 is representative of a network that provides the client device 102 and the endpoint device 104 with connectivity to various networks and/or services, such as the Internet. The network 106, for instance, enables data to be transmitted via a wired and/or wireless connection between the client device 102 and the endpoint device 104. The network 106 may be implemented via a variety of different connectivity technologies, such as broadband cable, digital subscriber line (DSL), wireless cellular, wireless data connectivity (e.g., WiFi™), T-carrier (e.g., T1), Ethernet, and so forth. In at least some implementations, the network 106 represents different interconnected wired and wireless networks.

The client device 102 includes a variety of different functionalities that enable various activities and tasks to be performed. For instance, the client device 102 includes an operating system 108, applications 110, a communication client 112a, a wireless module 114, and a location module 116. Generally, the operating system 108 is representative of functionality for abstracting various system components of the client device 102, such as hardware, kernel-level modules and services, and so forth. The operating system 108, for instance, can abstract various components of the client device 102 to the applications 110 to enable interaction between the components and the applications 110.

The applications 110 represent functionalities for performing different tasks via the client device 102. Examples of the applications 110 include a word processing application, a spreadsheet application, a web browser, a gaming application, and so forth. The applications 110 may be installed locally on the client device 102 to be executed via a local runtime environment, and/or may represent portals to remote functionality, such as cloud-based services, web apps, and so forth. Thus, the applications 110 may take a variety of forms, such as locally-executed code, portals to remotely hosted services, and so forth.

The communication client 112a is representative of functionality to enable different forms of communication via the client device 102, such as for communication between the client device 102 and the endpoint device 104. Examples of the communication client 112a include a voice communication application (e.g., a VoIP client), a UC client, a video communication application, a messaging application, a content sharing application, and combinations thereof. The communication client 112a, for instance, enables different communication modalities to be combined to provide diverse communication scenarios. In at least some implementations, the communication client 112a represents an application that is installed on the client device 102. Additionally or alternatively, the communication client 112a can be implemented as a portal to a remote application, such as accessed via a web browser, a web application, and so forth.

According to one or more implementations, communication between the client device 102 and the endpoint device 104 occurs between the communication client 112a and a communication client 112b of the endpoint device 104. The communication client 112b, for instance, represents an instance of the communication client 112a. For example, a communication session between the client device 102 and the endpoint device 104 represents an exchange of communication media between the communication client 112a and the communication client 112b. In at least some implementations, the communication clients 112a, 112b represents applications that execute at an application layer of their respective devices.

The wireless module 114 of the client device 102 is representative of functionality for enabling the client device 102 to communicate data wirelessly over the network 106. For instance, the wireless module 114 represents hardware and logic for data communication over the network 106 via a variety of different wireless technologies and protocols.

The wireless module 114 includes other components not expressly illustrated herein, such as an encryption module for encrypting and decrypting data, a radio frequency (RF) modulator for modulating and demodulating data, RF components (e.g., antennas, radios, and so forth) for transmitting and receiving RF signal, a codec for encoding and decoding data, and so forth.

The location module 116 is representative of functionality to determine a location of the client device 102. For example, the location module 116 may receive location information from one or more external location systems, such as Global Positioning System (GPS) coordinates from one or more GPS satellites, location information from a wireless cellular service, map information from a mapping service, and so forth. The location module 116 may provide such location information to other entities and functionalities, such as the various functionalities and entities discussed in the environment 100. As further detailed herein, location information may be utilized to identify preferred networks at a particular location for the client device 102.

The environment 100 further includes a communication service 118, which is representative of a service to perform various tasks for management of communication between the client device 102 and the endpoint device 104. The communication service 118, for instance, can manage initiation, moderation, and termination of communication sessions. Examples of the communication service 118 include a VoIP service, an online conferencing service, a UC service, and so forth. In at least some implementations, the communication service 118 may be implemented as or be connected to a private branch exchange (PBX) in communication with a Public Switched Telephone Network (“PSTN”) to enable voice communication between the client device 102 and the endpoint device 104.

According to one or more implementations, the communication clients 112a, 112b are managed and/or hosted by the communication service 118. For instance, the communication clients 112a, 112b represent interfaces to communication services provided by the communication service 118.

The environment 100 further includes a connectivity service 120, which is representative of a network-based (e.g., cloud-based) service that provides network intelligence to various entities. For instance, the connectivity service 120 provides network intelligence to the communication service 118, the client device 102, and/or the endpoint device 104. The connectivity service 120 maintains a connectivity database (DB) 122, which is representative of functionality for storing various network parameters and other information pertaining to network connectivity. Examples of different types of network information stored in the connectivity DB 122 are discussed below.

According to various implementations, the connectivity service 120 provides connectivity data from the connectivity DB 122 to the communication service 118, which forwards the connectivity data to the client device 102. The client device 102 stores the connectivity data as part of a network table 124, and the wireless module 114 utilizes the connectivity data to establish a connection to a particular network 106. The network connection, for instance, is utilized for transmission of data as part of a communication session between the client device 102 and the endpoint device 104.

In at least some implementations, the connectivity service 120 represents a service that is implemented and managed by the communication service 118. Alternatively, the connectivity service 120 represents a standalone service that provides intelligence pertaining to networks to a variety of different services and/or devices.

The various entities and functionalities discussed in the environment 100 may be implemented in software, hardware, firmware, and/or combinations thereof. Further details and implementations of the various entities of the environment 100 are discussed below.

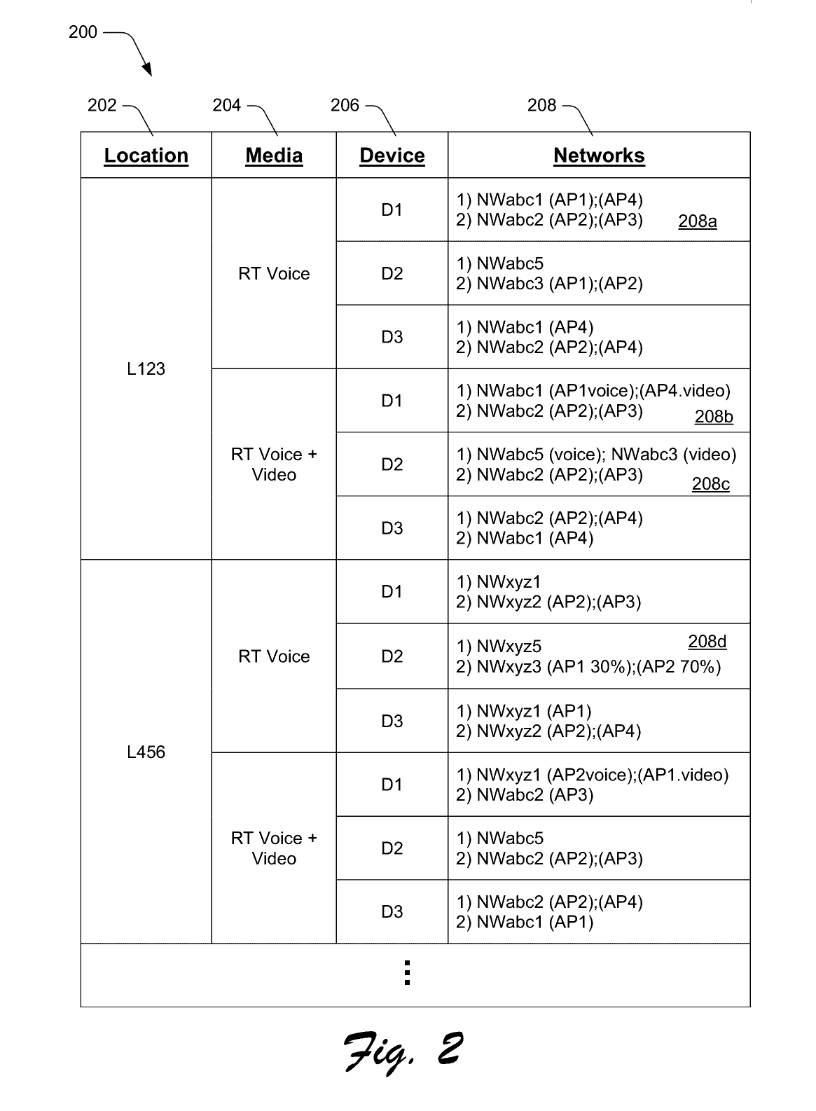

FIG. 2 depicts an example connectivity table 200 in accordance with one or more implementations. Generally, the connectivity table 200 includes location-specific information about different networks. The connectivity table 200, for instance, represents data stored as part of the connectivity DB 122 and/or the network table 124.

The connectivity table 200 includes a location column 202, a media column 204, a device column 206, and a networks column 208. The location column 202 identifies different locations at which network connectivity is available. Locations may be identified in the location column 202 in various ways, such as with reference to geographical coordinates (e.g., Global Positioning System (GPS) coordinates), a map-based location (e.g., city, street address, neighborhood, and so forth), a facility-based location (e.g., building name and/or number, room name and/or number, and so forth), and so on. In at least some implementations, a particular location may be associated with a distance threshold from a central point at the location such that if a device is determined to be within the distance threshold, the device is determined to be at the location. The distance threshold may be specified in various ways, such as in meters, yards, kilometers, and so forth.

The media column 204 identifies different types and combinations of communication media that can be transmitted as part of a communication session. In this particular example the media column 204 identifies real-time (“RT”) voice data and a combination of RT voice and video data. These particular implementations are presented for purpose of example only, and it is to be appreciated that various others types of media may be specified, such as messaging data, file data, streaming content data, and so forth.

The device column 206 identifies different types of devices, and may characterize devices in a variety of different ways. Examples of different ways of characterizing devices include manufacturer, model, device version, software/firmware configuration (e.g., wireless driver version), communication client type and/or version, and combinations thereof. The different device types “D1,” “D2,” and “D3” generally correspond to different respective device configurations.

The networks column 208 identifies different network preferences based on the information from the location column 202, the media column 204, and the device column 206. Generally, the individual entries under the networks column 208 identify preferred networks to be used in particular scenarios. Networks may be identified in various ways, such as network type (e.g., with respect to particular wired and/or wireless protocol), a network identifier, a network address (e.g., a Transmission Control Protocol/Internet Protocol (TCP/IP) address), and so forth. Further, individual entries in the networks column 208 provide a ranked list of preferred networks in descending order of preference. Examples of different network types that may be identified in the networks column 208 include broadband cable, DSL, wireless cellular, wireless data connectivity (e.g., WiFi™), T-carrier (e.g., T1), Ethernet, and so forth.

For instance, consider a table entry 208a in the networks column 208, which specifies a set of preferred networks for a particular scenario. In this particular example, the table entry 208a identifies a ranked list of preferred networks for a location “L123,” a media type “RT Voice,” and a device type “D1.” Based on this set of information, the table entry 208a identifies a most preferred network “NWabc1.” The table entry 208a further identifies preferred access points (“AP”) to be used for associating with the NWabc1, e.g., “AP1” and “AP4.” In at least some implementations, the APs are listed in order of preference, with a most preferred AP being listed first. Alternatively or additionally, multiple access points may be identified for the purpose of enabling multiple APs to be used for signal transmission, e.g., concurrently.

The table entry 208a also identifies “NWabc2” as a second preferred network. For instance, if the NWabc1 is determined to have high traffic, poor signal quality, and/or is unavailable, the NWabc2 may be utilized.

As another example, consider a table entry 208b which identifies preferred networks for the location L123, for RT voice and video combined, and for the device type D1. The table entry 208b identifies the NWabc1 as a preferred network, and further specifies that AP1 is to be used for transmitting voice data and AP4 is to be used for transmitting video data. Thus, a client device that matches the criteria for the table entry 208b can divide transmission of media data of a communication session over the NWabc1 such that RT voice data is transmitted over AP1 and video data is transmitted over AP4.

As a further example, consider a table entry 208c which identifies preferred networks for the location L123, for RT voice and video combined, and for a device type D2. The table entry 208c specifies that NWabc5 is a preferred network for voice data, and that NWabc3 is a preferred network for video data. Thus, a device meeting the set of criteria for table entry 208c can divide media data transmission of a communication session such that voice data is transmitted over NWabc5, and video data is transmitted over NWabc3. In at least some implementations, this divided transmission occurs simultaneously over the different networks. For instance, this allocation of data transmission is based on capabilities, capacity, and/or historic traffic across the different networks. Thus, multiple networks may be specified to provide higher bandwidth capacity and/or signal quality, and/or for load balancing purposes across the different networks.

As yet another example, consider a table entry 208d which identifies preferred networks for a location L456, for RT voice data, and for a device type D2. The table entry 208d identifies NWxyz5 as a most preferred network, and NWxyz3 as a next preferred network. The table entry 208d also specifies that for NWxyz3, signal transmission is to be allocated over multiple APs. For instance, the table entry 208d specifies that when using NWxyz3, 30% of voice data is to be transmitted over AP1, and 70% of voice data is to be transmitted over AP2. In at least some implementations, this allocation of data transmission is based on capabilities, capacity, and/or historic traffic across the different APs. Thus, multiple APs may be specified to provide higher bandwidth capacity and/or signal quality, and/or for load balancing purposes across a particular network.

While not expressly illustrated in FIG. 2, various other information may be included in the connectivity table 200. Examples of other information that may be specified include particular encoding methods for respective networks, network quality attributes for particular networks, security protocols utilized for particular networks, and so forth.

Thus, the connectivity table 200 is populated with information identifying preferred networks and/or APs for a variety of different scenarios. The particular scenarios (e.g., locations, media types, and device types) are presented for purpose of example only, and it to be appreciated that network preferences may be defined for a variety of different scenarios not specifically discussed herein.

Having described an example environment in which the techniques described herein may operate, consider now an example implementation scenario for preferred network information in accordance with one or more embodiments.

Example Implementation Scenario

The following section describes an example implementation scenario for preferred network information in accordance with one or more embodiments. The implementation scenario may be implemented in the environment 100 discussed above, and/or any other suitable environment.

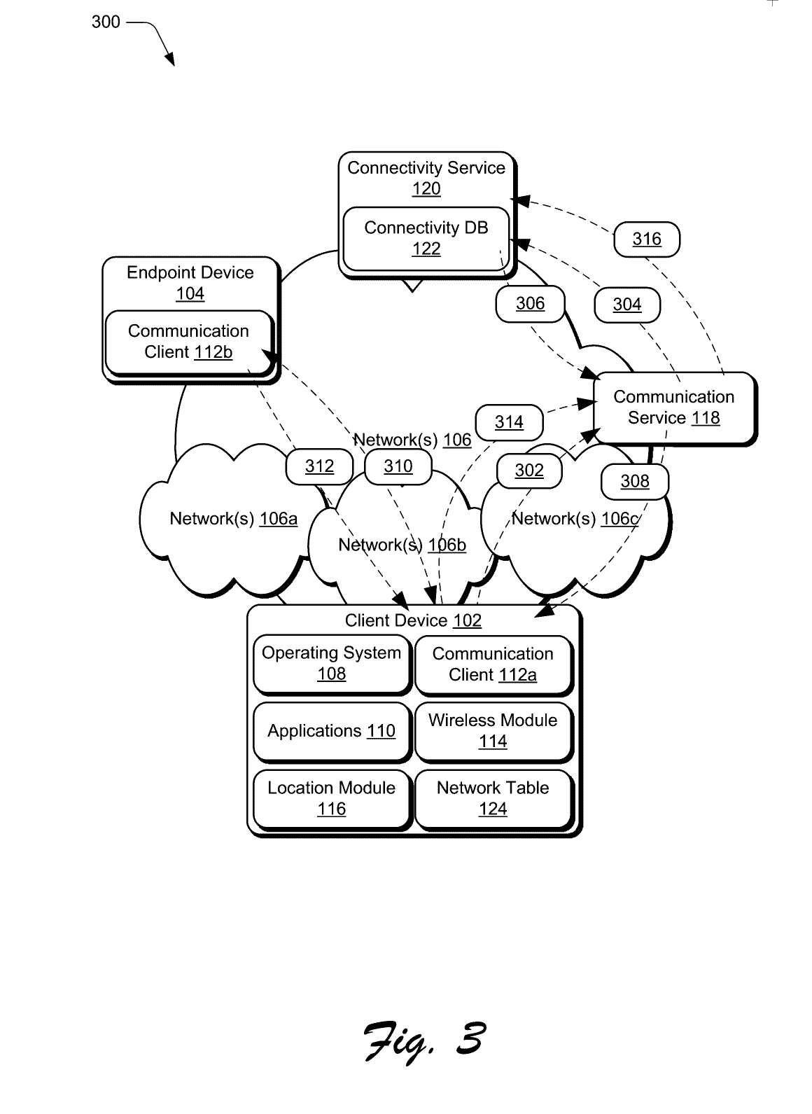

FIG. 3 depicts an example implementation scenario 300 for obtaining network information for a communication session in accordance with one or more implementations.

In addition to the various entities introduced above with reference to the environment 100, the scenario 300 includes a network 106a, a network 106b, and a network 106c. Generally, the networks 106a-106c represent different distinct networks that are available at a location of the client device 102. In at least some implementations, the networks 106a-106c are implemented and/or managed by different entities, such as different respective enterprise entities. Alternatively or additionally, the networks 106a-106c may each represent different network types, such as different network technologies and/or protocols. For instance, the network 106a may represent a wireless cellular network, the network 106b may represent a first wireless broadband network, and the network 106c may represent a second wireless broadband network. These examples of provided for purpose of illustration only, and it is to be appreciated that techniques for preferred network information discussed herein may be implemented according to a variety of different network types and technologies.

In the scenario 300, the client device 102 connects to the network 106c and communicates a network query 302 to the communication service 118 over the network 106c. In at least some implementations, the network 106c represents a default network and/or network type for the client device 102, such as based on wireless driver settings of the client device 102. Generally, the network query 302 includes various information for the client device 102, such as a device identifier (e.g., a media access control (MAC) address), a location, and a device type for the client device 102. The communication client 112a, for instance, queries the location module 116 for a location of the client device 102. The communication client 112a receives location information from the location module 116, generates the network query 302 to include the location information and device type information for the client device 102. The communication client 112a submits the network query 302 to the wireless module 114, which transmits the network query 302 to the communication service 118.

The communication service 118 receives the network query 302, and utilizes information from the network query 302 to generate a connectivity query 304. The connectivity query 304, for instance, identifies a device instance (e.g., a device ID), the location, and the device type of the client device 102. In at least some implementations, the connectivity query 304 may also identify a media type and/or media types that the client device 102 may exchange with other devices (e.g., the endpoint device 104) as part of a communication session. As an alternative to generating the connectivity query 304 in response to the network query 302, the communication service 118 may generate the connectivity query 304 independent of a query from the client device 102. For instance, the communication service 118 may detect that the client device 102 is at a particular location, and may automatically generate the connectivity query 304 in response. Accordingly, the communication service 118 communicates the connectivity query 304 to the connectivity service 120.

Further to the scenario 300, the connectivity service 120 utilizes information from the connectivity query 304 to query the connectivity DB 122 for preferred networks at a location of the client device 102. The connectivity DB 122, for instance, is queried with a location and device type for the client device 102. In at least some implementations, the connectivity DB 122 may also be queried with a media type. Accordingly, the connectivity service 120 identifies a preferred network for the client device 102, such as based on location, device type, and/or media type. The connectivity service 120 returns a connectivity response 306 to the communication service 118 that includes information identifying the preferred network. In at least some implementations, the connectivity response 306 identifies the client device 102 and includes a ranked list of preferred networks, a list of preferred access points, preferred networks for different media types, and so forth. Example types and arrangements of network information that may be included in the connectivity response 306 are discussed above with reference to the connectivity table 200.

Continuing with the scenario 300, the communication service populates a network response 308 with information from the connectivity response 306, and communicates the network response 308 to the client device 102. The client device 102 stores information from the network response 308 as part of the network table 124. For instance, the network table 124 is updated to identify preferred networks and access points at a location of the client device 102. Further, the network table 124 may be updated to differentiate different preferred networks based on different media types. Example types and arrangements of network information that may be populated to the network table 124 are discussed above with reference to the connectivity table 200.

Consider for purposes of the scenario 300 that the network information populated to the network table 124 specifies that for a particular media type, the network 106b is a preferred network for the client device 102. Accordingly, the client device 102 connects to the network 106b, and initiates a communication session 310 with the endpoint device 104 over the network 106b. The communication client 112a, for example, notifies the wireless module 114 that the network 106b is to be utilized for the communication session 310. In at least some implementations, the communication client 112a also specifies a particular AP and/or combination of APs of the network 106b to be used for the communication session 310. Accordingly, the wireless module 114 establishes a connection (e.g., associates) with the network 106b and optionally a specific AP or combination of APs, and communicates data of the communication session 310 over the network 106b. Generally, the communication session 310 represents an exchange of media data between the communication clients 112a, 112b, such as a VoIP call, a video call, a UC session, and/or combinations thereof. In at least some implementations, the client device 102 may disconnect from the network 106c in conjunction with connecting to the network 106b.

Continuing with the scenario 300, the endpoint device 104 returns signal feedback 312 to the client device 102. The signal feedback 312 may be communicated to the client device 102 while the communication session 310 is in progress, and/or after the communication session 310 is terminated. Generally, the signal feedback 312 specifies various attributes of the media stream for the communication session 310. Such attributes include signal quality, signal strength, error periodicity (e.g., whether errors in the signal are bursty or random), and so forth. Generally, a signal quality of a data stream can be determined in various ways. For instance, the signal quality can be determined based on an error rate (e.g., a bit error rate) detected as part of forward error correction (FEC) decoding. In at least some implementations, for example, a threshold error rate can be defined. Thus, a data stream that exceeds that threshold error rate can be characterized as having a poor signal quality. A data stream that does not exceed the threshold error rate can be characterized as having an acceptable and/or good signal quality.

Additionally or alternatively, signal quality can be determined based on average receive power for the signal. For instance, a data signal that has an average receive power that exceeds a threshold receive power can be characterized as having an acceptable signal quality. However, a data signal that has an average receive power that does not exceed the threshold receive power can be characterized as having a poor signal quality.

Accordingly, the client device 102 generates a feedback notification 314 that includes the signal feedback 312 and/or signal attributes detected at the client device 102 as part of the communication session 310. The feedback notification 314, for instance, specifies signal quality detected at the endpoint device 104 and/or the client device 102 as part of the communication session 310. The feedback notification 314 also identifies the network 106b and media type(s) communicated as part of the communication session 310. The client device 102 communicates the feedback notification 314 to the communication service 118, which forwards network feedback 316 to the connectivity service 120 that includes feedback from the feedback notification 314. Generally, the network feedback 316 identifies signal attributes (e.g., signal quality) experienced across the network 106b. The network feedback 316 may also identify a specific instance and/or instances of APs of the network 106b, and signal attributes across the different APs.

In at least some implementations, the signal attributes identified in the network feedback 316 are media specific for different types of media data. For instance, the network feedback 316 may specify that signal quality for video data met a threshold signal quality, but that signal quality for voice data was below a threshold signal quality. As further detailed below, the connectivity service 120 may utilize the network feedback 316 to update and/or optimize the connectivity DB 122.

In at least some implementations, the communication service 118 may periodically query the connectivity service 120 for updated network data for the client device 102. If the connectivity service 120 indicates that updated network data is available, the communication service 118 can obtain the updated network data and propagate the updated network data to the client device 102. In at least some implementations, determining whether updated connectivity data is available is performed by comparing a version indicator for the network table 124 of the client device 102 with a version indicator for the connectivity DB of the connectivity service 120. If this comparison indicates that updated network information is available from the connectivity service 120, the updated network is propagated to the client device 102, such as by the communication service 118.

As yet another example, the connectivity service 120 may push updated network data to the communication service 118, e.g., independently of a query from the communication service 118 and/or the client device 102 for updated network data. Thus, the communication service 118 may push the updated network data to the client device 102, such as to augment and/or replace the network table 124.

While the scenario 300 is discussed with reference to initiating the communication session 310 over the network 106b, consider an alternative scenario where the communication session 310 is initially established over the network 106c. After the communication session 310 is established over the network 106c, the client device 102 detects that other networks are available, such as the networks 106a, 106b. For instance, the client device 102 may be in motion and thus may come into range of the networks 106a, 106b.

Accordingly, the client device 102 queries the communication service 118 (e.g., via the network query 302) for information about the networks 106a, 106b, such as quality information for the networks 106a, 106b. The communication service 118 then queries the connectivity service 120 for quality information for the networks 106a, 106b, receives the quality information, and returns the quality information to the client device 102. The client device 102 compares the quality information to a signal quality of the network 106c to ascertain whether to perform a handover (e.g., a wireless handover) of the communication session 310 to one of the networks 106a, 106b.

For instance, consider that the network 106b has a signal quality that meets and/or exceeds a signal quality of the network 106c. Accordingly, the client device 102 initiates a handover of the communication session 310 from the network 106c to the network 106b such that the communication session 310 is rerouted from the network 106c to the network 106b. Alternatively, if the network 106b is determined to have a lower quality than the network 106c, and/or is determined to have a signal quality that is below a threshold signal quality, a handover of the communication session 310 to the network 106b may not be performed. Thus, implementations discussed herein enable intelligent decisions regarding whether to perform a network handover between available networks.

Accordingly, the scenario 300 illustrates that implementations discussed herein enable network information to be dynamically propagated to client devices in response to various events, such as in response to a query for network information, an initiation of a communication session, updates in network data, changes in signal attributes (e.g., signal quality) across a network, changes in network type, and so forth. While the scenario 300 is discussed with reference to the communication service 118 acting as an intermediary, in at least some implementations the client device 102 may interact directly with the connectivity service 120 to obtain network information and to provide session feedback.

Having discussed an example implementation scenario, consider now a discussion of some example procedures in accordance with one or more embodiments.

Example Procedures

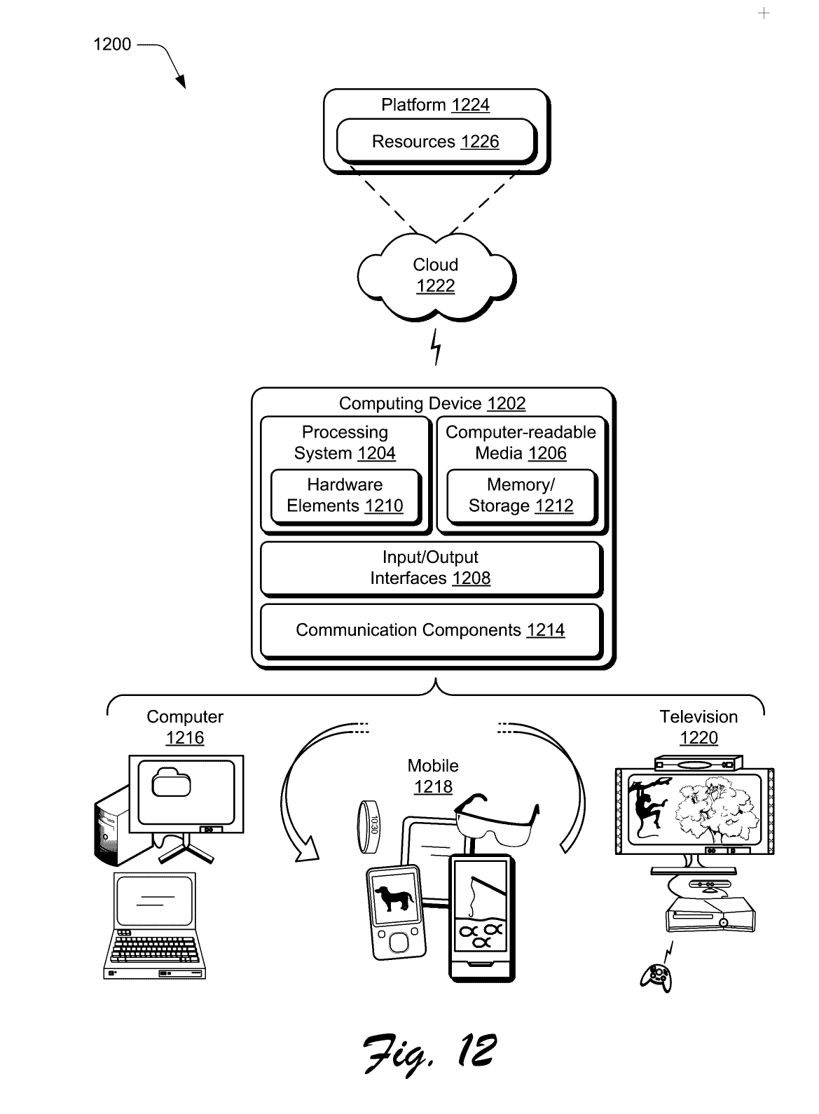

The following discussion describes some example procedures for preferred network information in accordance with one or more embodiments. The example procedures may be employed in the environment 100 of FIG. 1, the system 1200 of FIG. 12, and/or any other suitable environment. The procedures, for instance, represent procedures for implementing aspects of the example implementation scenario discussed above. In at least some implementations, the steps described for the various procedures can be implemented automatically and independent of user interaction.

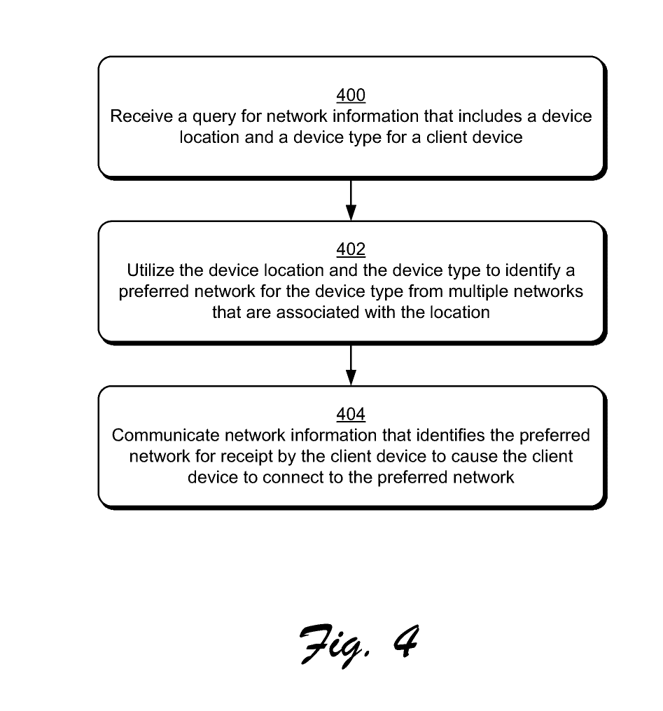

FIG. 4 is a flow diagram that describes steps in a method in accordance with one or more embodiments. The method describes an example procedure for communicating network information in accordance with one or more implementations. In at least some implementations, the method is performed at a network-based service, such as at the communication service 118 and/or the connectivity service 120.

Step 400 receives a query for network information that includes a device location and a device type for a client device. The communication service 118, for instance, receives a query from the client device 102 that identifies a location of the client device 102 and a device type for the client device 102. The query may also identify one or more media types, such as a media type to be transmitted as part of a communication session.

Alternatively or additionally, the communication service 118 detects a location and device type for the client device 102, e.g., independent of a query from the client device 102 for network information. For instance, the communication client 112a initiates a communication session via interaction with the communication service 118, and in response the communication service 118 detects a location and device type for the client device 102. In at least some implementations, the communication service 118 also detects a media type transmitted as part of the communication session.

In yet another example implementation, the client device 102 queries the connectivity service 120 directly for network information. The client device 102, for instance, queries the connectivity service 120 with its location, its device type, and one or more media types.

In at least some implementations, a query for network information may also include a version indicator indicating a version for network information that was previously retrieved. For instance, the communication service 118 includes a version indicator in the query to the connectivity service 120 for network information. The version indicator, for example, identifies a version of network information that was previously retrieved from the connectivity service 120 and communicated to the client device 102. Thus, the connectivity service 120 may ascertain based on the version indicator whether an updated version of network information is available.

According to one or more implementations, device type information received in the query may be specified in various ways. For instance, device type may be directly identified in the query, such as by directly specifying the device manufacturer, device model, device version, and so forth. Alternatively or additionally, the query may include a device ID (e.g., a MAC address) of the device, and the connectivity service 120 may perform a table lookup using the device ID to identify a device manufacturer, device model, and/or device version that matches the device ID.

Step 402 utilizes the device location and the device type to identify a preferred network for the device type from multiple networks that are associated with the location. The connectivity service 120, for instance, queries the connectivity DB 122 with the device location and the device type to identify a preferred network. In addition to location and device type, a media type may also be used to query for a preferred network. In at least some implementations, multiple preferred networks may be identified, such as a ranked list of preferred networks at the particular location. For instance, at least some networks associated with the location may be excluded based on the networks not being preferred networks. In addition to a preferred network, preferred access points may also be identified.

Preferred networks may be identified in various ways. For instance, a network that is historically known to have a higher signal quality than other networks for a particular device type and media type may be tagged as a preferred network. Example ways of characterizing signal quality are discussed below. Network security may also be considered. For example, a network that is historically known to implement stricter data security procedures than other networks can be tagged as a preferred network.

Step 404 communicates network information that identifies the preferred network for receipt by the client device to cause the client device to connect to the preferred network. The connectivity service 120, for instance, communicates the network information to the communication service 118, which forwards the network information to the client device 102. Alternatively, the connectivity service 120 communicates the network information directly to the client device 102.

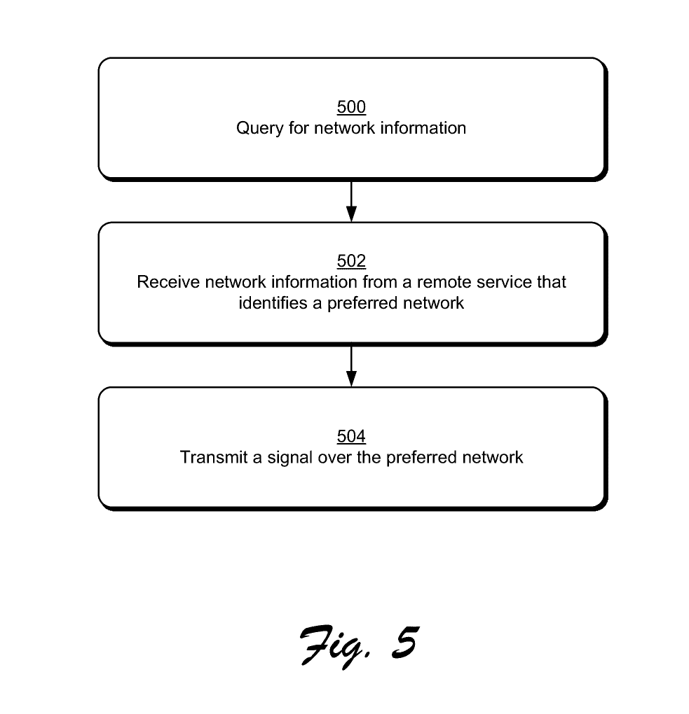

FIG. 5 is a flow diagram that describes steps in a method in accordance with one or more embodiments. The method describes an example procedure for receiving network information in accordance with one or more implementations. In at least some implementations, the method is performed at an end-user device, such as at the client device 102.

Step 500 queries for network information. The client device 102, for instance, queries the communication service 118 and/or the connectivity service 120 for network information. The query includes various information pertaining to a querying device, such as a device ID, a device location, a device type, a media type, and so forth.

Generally, the query may be initiated in response to various events. For instance, the client device 102 may query for network information in response to moving from one location to another. Alternatively or additionally, the client device 102 may query for network information in response to initiation of a communication session.

Alternatively or additionally, the client device 102 may query for network information in response to detecting that a network is available to perform a handover of an active communication session. An example procedure for a handover scenario is described below.

Step 502 receives network information from a remote service that identifies a preferred network. The network information, for instance, identifies a preferred network at a particular location and from multiple different networks that are available at the location. In at least some implementations, the network information identifies multiple preferred networks, such as a ranked list of preferred networks. Further, the network information may identify preferred networks for transmitting a specific media type and from multiple available networks at a location of the querying device. The network information may further identify preferred access points at a particular preferred network.

Step 504 transmits a signal over the preferred network. The client device 102, for instance, connects to the preferred network and transmits signal that includes media data of a communication session over the preferred network. In at least some implementations, the signal includes media data of a specific media type identified in the query for network information. In scenarios where the network information identifies a preferred access point or set of access points, the signal is transmitted over the identified access point(s).

According to one or more implementations, the network information may be received prior to initiating a communication session. Thus, a connection to the preferred network may be established and a communication session initiated over the preferred network. Alternatively, the network information may be received after a communication session is initiated over a different network. Thus, a handover of the communication session may be performed from the different network to the preferred network while the communication session is in progress, e.g., without interrupting the communication session.

In at least some implementations, the network information may specify that data transmission is to be divided among multiple access points and/or networks. Thus, a media stream of a single instance of a communication session can be divided into multiple substreams, and the individual substreams can be transmitted over different respective access points and/or networks. The network information may also specify a respective allocation for each access point and/or network, such as in terms of a fraction (e.g., percentage) of media data to be transmitted over each access point/network. Thus, a stream of media data may be divided according to the specified allocations, and each allocation transmitted over a respective access point/network.

According to one or more implementations, utilizing the preferred network for data transmission overrides a default connectivity behavior of the client device 102. For instance, a wireless driver or other functionality of the client device 102 may specify that a different network is to be used for network connectivity. However, the network information specifies that the preferred network is to be used instead of the different network. Accordingly, the client device 102 utilizes the network information to override the default behavior and connects to the preferred network instead of the different network.

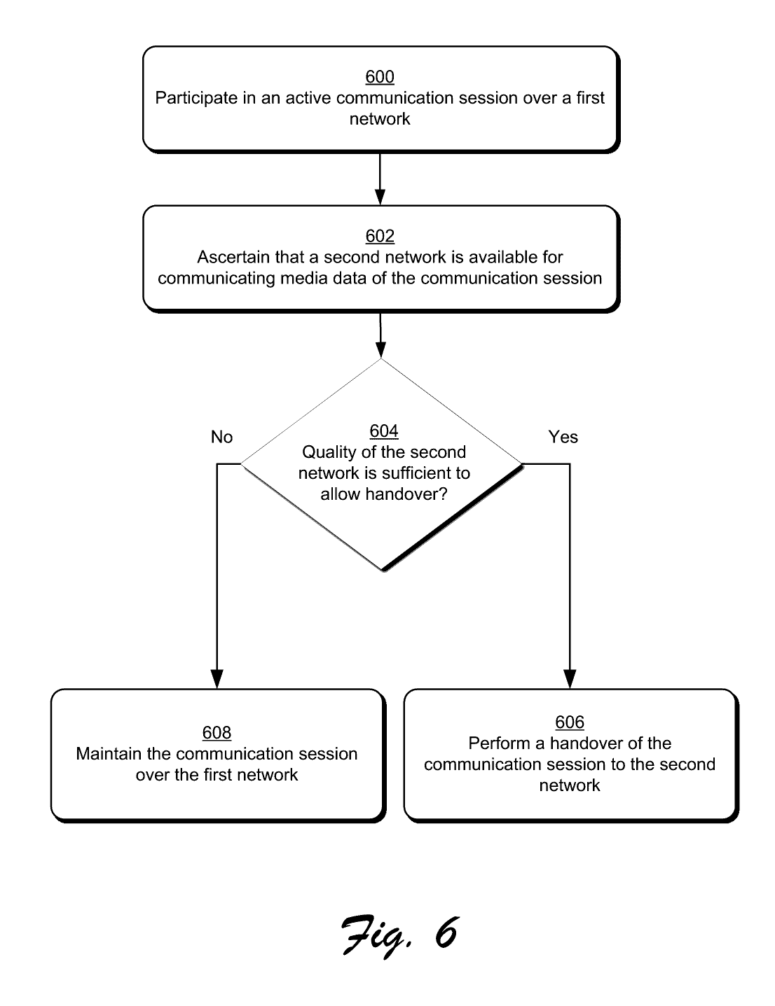

FIG. 6 is a flow diagram that describes steps in a method in accordance with one or more embodiments. The method describes an example procedure for determining whether to perform a handover based on network information in accordance with one or more implementations. In at least some implementations, the method is performed at an end-user device, such as at the client device 102.

Step 600 participates in an active communication session over a first network. The client device 102, for instance, participates in a communication session with the endpoint device 104 over a particular network.

Step 602 ascertains that a second network is available for communicating media data of the communication session. For example, the client device 102 detects that a different network is available to connect to and transmit data of the communication session. For example, the client device 102 is in motion, such as a mobile device in possession of a user that is in motion. Accordingly, the mobile device arrives at a location where the second network is available.

As an example scenario, consider that the user in possession of the client device 102 is commuting and establishes the communication session over a data connection provided by a wireless cellular network, such as a Long Term Evolution (LTE) network. The user then arrives at an enterprise location that provides connectivity to a WiFi™ network. Thus, while the client device 102 is connected to the wireless cellular network and is transmitting data via the wireless cellular network, the client device 102 detects the presence of the WiFi™ network.

Step 604 ascertains whether a quality of the second network is sufficient to allow a handover of the communication session from the first network to the second network. Generally, determining a quality of the second network can be performed in various ways. The client device 102, for example, can communicate a query to the connectivity service 120 that identifies the first network and the second network, and that asks whether a handover of the communication session from the first network and the second network is to be performed. In at least some implementations, the client device 102 queries the communication service 118, which queries the connectivity service 120 on behalf of the client device 102. The connectivity service 120, for instance, queries the connectivity DB 122 with this information and compares a quality indicator for the first network to a quality indicator for the second network.

Alternatively, the client device 102 queries its own network table 124 with this information to ascertain whether the second network is identified in the network table 124 and if it is, whether the second network is of sufficient quality to permit a handover to the second network. Different ways of characterizing signal quality of a network are described above.

If a comparison of the quality of the second network to a quality of the first network indicates that the second network is a lower quality network than the first network, the connectivity service 120 returns a response to the client device 102 indicating that a handover to the second network is not to be performed. However, if the second network is determined to be of equal or greater quality than the first network, the connectivity service 120 returns a response to the client device 102 indicating that a handover to the second network is to be performed.

Alternatively, a quality of the second network is compared to a pre-specified quality threshold that is defined independently of the first network. Thus, if a quality of the second network meets or exceeds the quality threshold, an instruction is generated to perform a handover. Otherwise, if the quality of the second network is below the quality threshold, an instruction is generated to not perform a handover.

If the second network is of sufficient quality (“Yes”), step 606 performs a handover of the communication session to the second network. A query response from the connectivity service 120 and/or the network table 124, for example, specifies that the second network is of sufficient quality to perform a handover. Thus, a wireless handover is performed from the first network to the second network and while the communication session is active, e.g., without interrupting the communication session.

If the second network is not of sufficient quality (“No”), step 608 maintains the communication session over the first network. A query response from the connectivity service 120 and/or the network table 124, for example, specifies that the second network is not of sufficient quality to permit a handover. Thus a wireless handover of the communication session to the second network is not performed, and connectivity for the communication session is persisted over the first network.

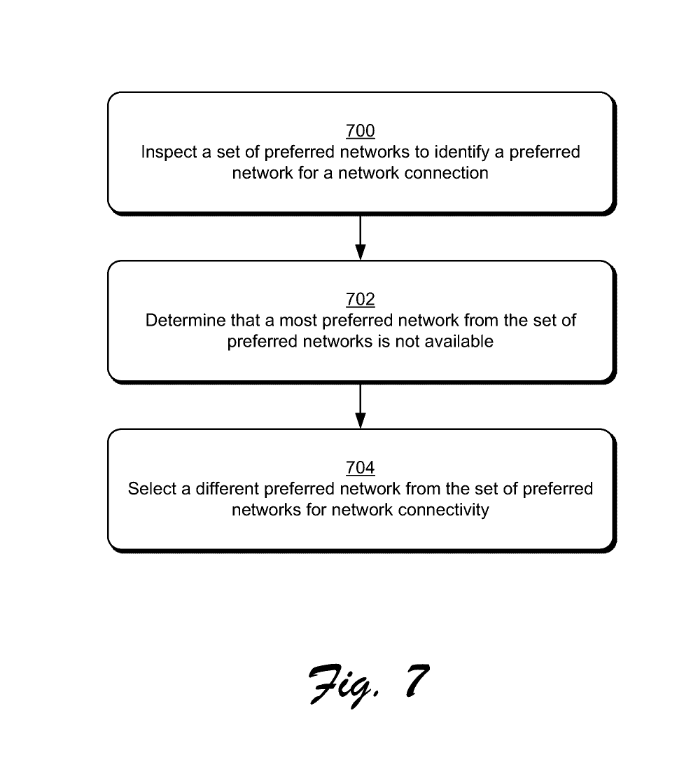

FIG. 7 is a flow diagram that describes steps in a method in accordance with one or more embodiments. The method describes an example procedure for selecting a network from a set of preferred networks in accordance with one or more implementations. In at least some implementations, the method is performed at the client network 106.

Step 700 inspects a set of preferred networks to identify a preferred network for a network connection. For example, the client device 102 inspects a ranked list of preferred networks received from the connectivity service 120. The ranked list, for instance, is saved as part of the network table 124, and corresponds to a set of preferred networks that are available at a location of the client device 102.

Step 702 determines that a most preferred network from the set of preferred networks is not available. For example, the client device 102 determines that the most preferred network is not detected. A network beacon from the most preferred network, for instance, is not detected. As another example, the client device 102 may detect that the most preferred network is detected but is exhibiting a quality-related problem. For example, the client device 102 attempts to connect to the most preferred network, but receives an indication of an error and/or other quality-related problem from the most preferred network. Thus, the client device 102 ascertains that the most preferred network is not a suitable candidate for network connectivity.

Step 704 selects a different preferred network from the set of preferred networks for network connectivity. For example, the client device 102 selects a different preferred network that is indicated in the network table 124 as being available at a current location. The different preferred network, for instance, is a lower ranked network than the most preferred network in the list of preferred networks. The client device 102 ascertains that the different preferred network is available, and thus connects to the different preferred network.

According to one or more implementations, the procedures described above with reference to FIGS. 6 and 7 can be combined in a handover scenario. For instance, when the client device 102 detects that multiple preferred networks are available for a handover but that a most preferred network is not of sufficient quality for the handover, the client device 102 may select a different preferred network for the handover.

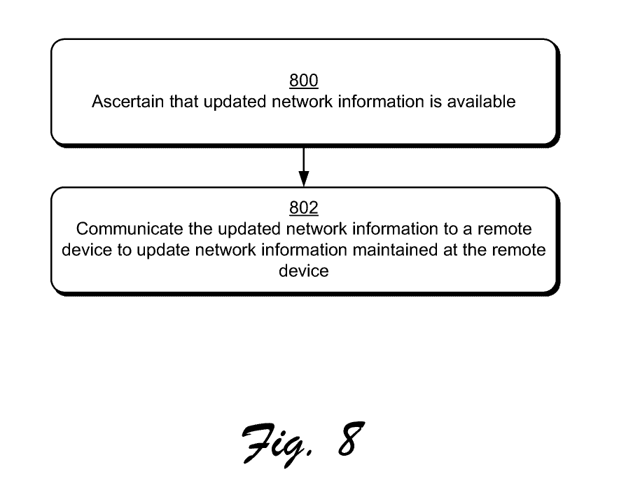

FIG. 8 is a flow diagram that describes steps in a method in accordance with one or more embodiments. The method describes an example procedure for communicating updated network information in accordance with one or more implementations. In at least some implementations, the method is performed at a network-based service, such as at the communication service 118 and/or the connectivity service 120.

Step 800 ascertains that updated network information is available. The communication service 118, for instance, queries the connectivity service 120 to ascertain whether updated network information is available. For example, the communication service 118 queries the connectivity service 120 with a version indicator that identifies a most recent version of network information that was communicated to the client device 102. The communication service 118 returns a query response to the communication service 118 that includes updated network information. The updated network information, for example, has a version indicator that is more recent than the version indicator received as part of the query from the communication service 118.

Step 802 communicates the updated network information to a remote device to update network information maintained at the remote device. For example, the communication service 118 communicates the updated network information to the client device 102 to enable the client device 102 to utilize the updated network information for network connectivity for a communication session with the endpoint device 104. The client device 102, for instance, updates (e.g., replaces and/or augments) network information in the network table 124 with the updated network information.

In at least some implementations, this method may be performed in various ways. For instance, the method may be performed periodically to keep network information at the client device up-to-date, such as daily, weekly, and so forth. Alternatively or additionally, the method may be performed in response to a particular event, such as a query from the client device 102 for updated network information, a prompt from the connectivity service 120 that updated network information is available, an indication that the client device 102 has moved from one location to another, and so forth.

In at least some implementations, the method may be performed dynamically and while a communication session is in progress. For instance, network information maintained by the network table 124 may be updated dynamically while the client device 102 is engaged in a communication session. Further, the updated network information may be applied dynamically to perform a handover of the communication session to a preferred network identified in the updated network information.

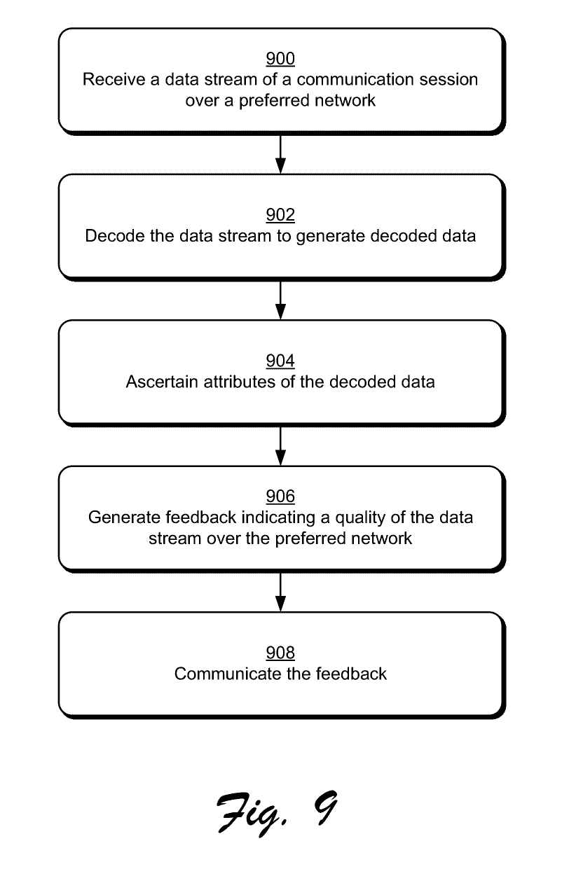

FIG. 9 is a flow diagram that describes steps in a method in accordance with one or more embodiments. The method describes an example procedure for generating feedback for a data stream of a communication session in accordance with one or more implementations. In at least some implementations, the method is an extension of the procedures described above. The method, for instance, may be performed at a device participating in a communication session, such as by the client device 102 and/or the endpoint device 104.

Step 900 receives a data stream of a communication session over a preferred network. The preferred network, for instance, is identified according to the various techniques described herein. Generally, the data stream includes media data transmitted by a device involved in the communication session. The client device 102, for instance, receives a data stream that includes data transmitted wirelessly by the endpoint device 104 as part of a communication session between the endpoint device 104 and the client device 102.

Step 902 decodes the data stream to generate decoded data. The wireless module 114, for example, performs various decoding processes on the data stream, such as demodulation, decryption, de-interleaving, FEC decoding, and so forth.

Step 904 ascertains attributes of the decoded data. The wireless module 114, for instance, inspects the decoded data for different types of errors and other signal properties, such as packet delay, packet loss rate, jitter, packet errors (e.g., number and/or rate), signal strength, and so forth. Alternatively or additionally, the wireless module 114 characterizes whether errors detected in the decoded data occur randomly or are bursty.

Step 906 generates feedback indicating a quality of the data stream over the preferred network. According to various implementations, the feedback may specify a general quality of the data stream received at the endpoint device, such as “good,” “acceptable,” “poor,” and so forth. Alternatively or additionally, the feedback may include quality and/or error statistics for the data stream. Example statistics that can be specified by the feedback include:

(1) Mean Opinion Score (MOS): This attribute can be leveraged to specify a MOS for a communication session. The attribute, for instance, can be used to indicate an overall quality of a communication session.

(2) Jitter Inter-Arrival Time: This attribute can be leveraged to specify jitter values for a communication session. The attribute, for instance, can be used to indicate that a jitter value or values have increased, e.g., have exceeded a specified jitter value threshold.

(3) Packet Loss Rate: This attribute can be leveraged to specify a packet loss rate for a communication session. The attribute, for instance, can be used to indicate that a packet loss rate has increased, e.g., has exceeded a specified packet loss rate value threshold.

(4) Packet Error Rate: This attribute can be leveraged to specify a packet error rate for a communication session. The attribute, for instance, can be used to indicate that a packet error rate has increased, e.g., has exceeded a specified packet error rate value threshold.

(5) Round Trip Delay (RTD): This attribute can be leveraged to specify RTD values for packets in communication sessions. The attribute, for instance, can be used to indicate that RTD values for packets have increased, e.g., have exceeded a specified RTD value threshold.

(6) Concealment Ratio: This attribute can be leveraged to specify a cumulative ratio of concealment time over speech time observed after starting a communication session. The attribute, for instance, can be used to specify that a concealment ratio has increased, e.g., has exceeded a specified concealment ratio value threshold.

Step 908 communicates the feedback. The feedback, for instance, identifies the preferred network and includes values for one or more of the signal attributes described above. Alternatively or additionally, the feedback characterizes a signal quality of the wireless signal, such as “good,” “acceptable,” “bad,” “bursty errors,” “random errors,” and so forth. In at least some implementations, the feedback may identify a specific AP or set of APs utilized to connect to the preferred network. For example, the client device 102 and/or the endpoint device 104 communicate the feedback to the communication service 118 and/or the connectivity service 120. Thus, communication service 118 and/or the connectivity service 120 may ascertain whether to perform an action based on the feedback, such as whether to update the connectivity DB 122, to suggest a different preferred network to the client device 102, and so forth.

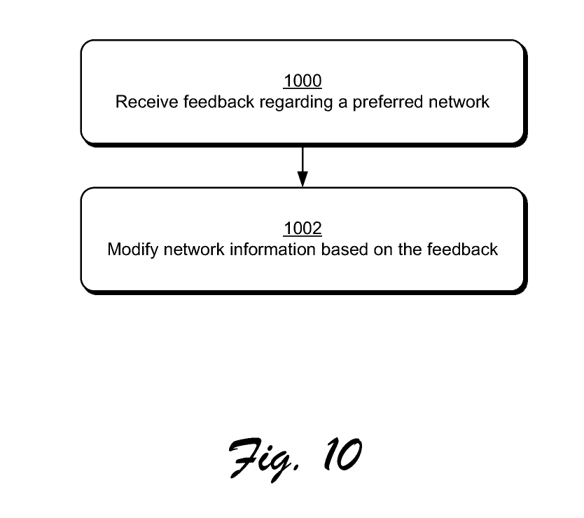

FIG. 10 is a flow diagram that describes steps in a method in accordance with one or more embodiments. The method describes an example procedure for modifying network information in accordance with one or more implementations.

Step 1000 receives feedback regarding a preferred network. The connectivity service 120, for instance, receives feedback regarding session quality experienced during a communication session over a preferred network, such as from the communication service 118, the client device 102, and/or the endpoint device 104. Generally, the feedback correlates network information such as network ID and AP ID to media types, device type for the client device 102, and session quality. For example, the feedback specifies that for a communication session over a preferred network and involving a particular media type and device type, a particular session quality was experienced. Session quality may be specified in different ways, such as errors experienced during a communication session, user feedback regarding session quality, and so forth. The feedback may include feedback regarding multiple different media types and across multiple different communication sessions. Examples of different types of feedback are detailed above.

Step 1002 modifies network information based on the feedback. The connectivity service 120, for instance, modifies (e.g., updates) the connectivity DB 122 based on the feedback. For example, the connectivity service 120 reconfigures a list of preferred networks at a particular location and for a particular device type and/or media type based on the feedback. Consider, for example, that the feedback specifies a threshold number of errors were detected in media data and/or a poor user experience for a communication session over the preferred network. Accordingly, the connectivity service 120 may demote the preferred network in a set of preferred networks at a particular location, or may remove the preferred network from the set. As another example, the feedback may be positive, such as indicating a positive user experience and/or a high signal quality for a preferred network. Thus, the preferred network may be promoted in a set of preferred network based on the positive feedback. Accordingly, negative feedback and positive feedback regarding a preferred network may be utilized to reconfigure a set of preferred networks.

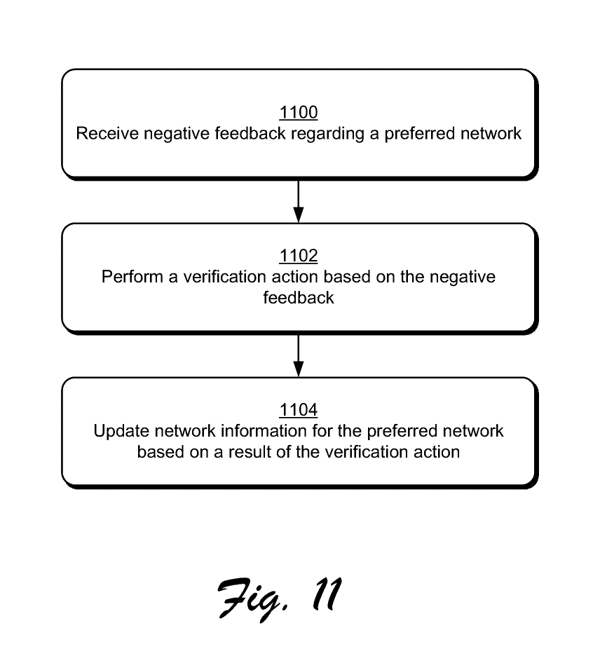

FIG. 11 is a flow diagram that describes steps in a method in accordance with one or more embodiments. The method describes an example procedure for verifying network feedback in accordance with one or more implementations.

Step 1100 receives negative feedback regarding a preferred network. The connectivity service 120, for instance, receives negative feedback regarding a preferred network at a particular location. Examples of different types and attributes of feedback are described above.

Step 1102 performs a verification action based on the negative feedback. For example, the connectivity service 120 queries an entity associated with the preferred network for network status information. The connectivity service 120, for instance, queries one or more infrastructure components of the preferred network to ascertain whether the components are functioning properly. Examples of such infrastructure components include switches, routers, gateways, and so forth.

Alternatively or additionally, the connectivity service 120 may query the communication service 118 to ascertain whether other indications of negative feedback regarding the preferred network have been received. For instance, different client devices connected to the preferred network may report feedback to the communication service, such as negative feedback. The communication service 118 may also detect poor signal quality across the preferred network for communication sessions managed by the communication service 118.

In yet another example implementation, the connectivity service 120 may initiate a test procedure for testing a quality of the preferred network. For example, the connectivity service 120 may cause simulated communication media to be transmitted across the preferred network, such as part of a simulated communication session. The connectivity service 120 may then determine a signal quality experienced for the simulated communication media across the preferred network. Different ways of characterizing signal quality are discussed above, such as with respect to errors detected in media data.

Step 1104 updates network information for the preferred network based on a result of the verification action. For instance, if the verification action indicates that the preferred network is experiencing quality problems, the connectivity service 120 may demote the preferred network in a list of preferred networks, or may remove the preferred network from the list. However, if the verification action indicates that a signal quality across the preferred network is acceptable (e.g., meets or exceeds a quality threshold), the connectivity service 120 may ignore the negative feedback. The negative feedback, for instance, may be indicative of a temporary quality issue that arose in the preferred network, such as temporary signal interference that is not indicative of a persistent quality issue. Thus, the connectivity service 120 may mark the negative feedback to be ignored, and/or may delete the negative feedback from the connectivity DB 122.

Having discussed some example procedures, consider now a discussion of an example system and device in accordance with one or more embodiments.

Example System and Device

FIG. 12 illustrates an example system generally at 1200 that includes an example computing device 1202 that is representative of one or more computing systems and/or devices that may implement various techniques described herein. For example, the client device 102, the endpoint device 104, the communication service 118, and/or the connectivity service 120 discussed above with reference to FIG. 1 can be embodied as the computing device 1202. The computing device 1202 may be, for example, a server of a service provider, a device associated with the client (e.g., a client device), an on-chip system, and/or any other suitable computing device or computing system.

The example computing device 1202 as illustrated includes a processing system 1204, one or more computer-readable media 1206, and one or more Input/Output (I/O) Interfaces 1208 that are communicatively coupled one to another. Although not shown, the computing device 1202 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1204 is representative of functionality to perform one or more operations using hardware. Accordingly, the processing system 1204 is illustrated as including hardware element 1210 that may be configured as processors, functional blocks, and so forth. This may include implementation in hardware as an application specific integrated circuit or other logic device formed using one or more semiconductors. The hardware elements 1210 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1206 is illustrated as including memory/storage 1212. The memory/storage 1212 represents memory/storage capacity associated with one or more computer-readable media. The memory/storage 1212 may include volatile media (such as random access memory (RAM)) and/or nonvolatile media (such as read only memory (ROM), Flash memory, optical disks, magnetic disks, and so forth). The memory/storage 1212 may include fixed media (e.g., RAM, ROM, a fixed hard drive, and so on) as well as removable media (e.g., Flash memory, a removable hard drive, an optical disc, and so forth). The computer-readable media 1206 may be configured in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1202 may be configured in a variety of ways as further described below to support user interaction.

The computing device 1202 further includes communication components 1214, which are representative of functionality to receive and transmit data for the computing device 1202. For instance, the communication components 1214 represent components for interfacing and communicating with a network, such as via any suitable wired and/or wireless protocol. According to various implementations, the communication components 1214 receive data transmitted to the computing device 1202 and route the data to one or more other components of the computing device 1202. Further, the communication components 1214 receive data from one or more internal components of the computing device 1202, and cause the data to be communicated to various entities (e.g., devices) remote from the computing device 1202.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1202. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1202, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1210 and computer-readable media 1206 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1210. The computing device 1202 may be configured to implement particular instructions and/or functions corresponding to the software and/or hardware modules. Accordingly, implementation of modules that are executable by the computing device 1202 as software may be achieved at least partially in hardware, e.g., through use of computer-readable storage media and/or hardware elements 1210 of the processing system. The instructions and/or functions may be executable/operable by one or more articles of manufacture (for example, one or more computing devices 1202 and/or processing systems 1204) to implement techniques, modules, and examples described herein.

As further illustrated in FIG. 12, the example system 1200 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1200, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1202 may assume a variety of different configurations, such as for computer 1216, mobile 1218, and television 1220 uses. Each of these configurations includes devices that may have generally different constructs and capabilities, and thus the computing device 1202 may be configured according to one or more of the different device classes. For instance, the computing device 1202 may be implemented as the computer 1216 class of a device that includes a personal computer, desktop computer, a multi-screen computer, laptop computer, netbook, and so on.

The computing device 1202 may also be implemented as the mobile 1218 class of device that includes mobile devices, such as a mobile phone, portable music player, portable gaming device, a tablet computer, a wearable device, a multi-screen computer, and so on. The computing device 1202 may also be implemented as the television 1220 class of device that includes devices having or connected to generally larger screens in casual viewing environments. These devices include televisions, set-top boxes, gaming consoles, and so on.

The techniques described herein may be supported by these various configurations of the computing device 1202 and are not limited to the specific examples of the techniques described herein. For example, functionalities discussed with reference to the communication service 118 and the connectivity service 120 may be implemented all or in part through use of a distributed system, such as over a “cloud” 1222 via a platform 1224 as described below.

The cloud 1222 includes and/or is representative of a platform 1224 for resources 1226. The platform 1224 abstracts underlying functionality of hardware (e.g., servers) and software resources of the cloud 1222. The resources 1226 may include applications and/or data that can be utilized while computer processing is executed on servers that are remote from the computing device 1202. Resources 1226 can also include services provided over the Internet and/or through a subscriber network, such as a cellular or Wi-Fi network.

The platform 1224 may abstract resources and functions to connect the computing device 1202 with other computing devices. The platform 1224 may also serve to abstract scaling of resources to provide a corresponding level of scale to encountered demand for the resources 1226 that are implemented via the platform 1224. Accordingly, in an interconnected device embodiment, implementation of functionality described herein may be distributed throughout the system 1200. For example, the functionality may be implemented in part on the computing device 1202 as well as via the platform 1224 that abstracts the functionality of the cloud 1222.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Implementations discussed herein include:

### Example 1

A system for identifying a preferred network for a client device, the system including: at least one processor; and one or more computer-readable storage media including instructions stored thereon that, responsive to execution by the at least one processor, cause the system perform operations including: receiving a query for network information, the query including a device location and a device type for a client device; utilizing the device location and the device type to identify a preferred network for the device type from multiple networks that are associated with the location; and communicating network information that identifies the preferred network for receipt by the client device to enable the client device to connect to the preferred network.

### Example 2

A system as described in example 1, wherein said query is received in response to initiation of a communication session involving the client device.

### Example 3

A system as described in one or more of examples 1 or 2, wherein said the device type specifies one or more of a device manufacturer, a device model, or a device driver configuration.

### Example 4

A system as described in one or more of examples 1-3, wherein said query includes a database query by an entity that maintains the database.

### Example 5

A system as described in one or more of examples 1-4, wherein the query further includes one or more media types, and wherein said utilizing further includes utilizing the one or more media types to identify the preferred network.

### Example 6

A system as described in one or more of examples 1-5, wherein said utilizing further includes utilizing the device location and the device type to identify multiple preferred networks associated with the location including the preferred network, and wherein the network information identifies the multiple preferred networks.

### Example 7

A system as described in one or more of examples 1-6, wherein said utilizing further includes utilizing the device location and the device type to identify multiple preferred networks associated with the location including the preferred network, and wherein the network information identifies the multiple preferred networks as a ranked list of preferred networks.

### Example 8

A system as described in one or more of examples 1-7, wherein the network information further identifies one or more preferred access points for the preferred network.

### Example 9

A system as described in one or more of examples 1-8, wherein the operations further include: receiving feedback regarding the preferred network; and modifying network information for the preferred network based on the feedback.

### Example 10

A system as described in one or more of examples 1-9, wherein the operations further include: receiving negative feedback regarding a preferred network; performing a verification action based on the negative feedback; and updating network information for the preferred network based on a result of the verification action.

### Example 11

A computer-implemented method for using a preferred network for transmitting media data, the method including: receiving at a client device network information from a remote service, the network information identifying a preferred network for transmitting a specific media type from the client device and from multiple networks associated with a location of the client device; and transmitting a signal over the preferred network that includes media data of the specific media type.

### Example 12

A method as described in example 11, wherein the media data is generated via an application that is executable at an application layer of the client device.

### Example 13

A method as described in one or more of examples 11 or 12, further including querying for network information in response to initiation of a communication session, and wherein said receiving the network information occurs in response to said querying.

### Example 14

A method as described in one or more of examples 11-13, further including querying for network information in response to initiation of a communication session, said querying including specifying a location of the client device and a device type of the client device, and wherein said receiving the network information occurs in response to said querying.

### Example 15

A method as described in one or more of examples 11-14, wherein said transmitting the signal over the preferred network overrides a default connectivity behavior of the client device.

### Example 16

A method as described in one or more of examples 11-15, further including: querying for network information in response to ascertaining that the preferred network is available to perform a wireless handover of a communication session from a different network, the network information specifying that a quality of the preferred network is sufficient to allow the wireless handover; and performing a wireless handover to the preferred network prior to transmitting the signal over the preferred network, the signal including media data of the communication session.

### Example 17

A method as described in one or more of examples 11-16, further including: generating feedback indicating a quality of a data stream received over the preferred network; and communicating the feedback to the remote service.

### Example 18

A computer-implemented method modifying network information for a preferred network, the method including: receiving feedback for a preferred network associated with a particular location and for a particular device type; and modifying network information for the preferred network and for the particular device type based on the feedback.

### Example 19

A method as described in example 18, wherein the feedback indicates a quality problem with the preferred network, and wherein said modifying includes one or more of demoting the preferred network in a list of preferred networks, or removing the preferred network from the list of preferred networks.

### Example 20

A method as described in one or more of examples 18 or 19, wherein the feedback indicates a quality problem with the preferred network, and wherein the method further includes: performing a verification action based on the negative feedback; and updating network information for the preferred network based on a result of the verification action.

### CONCLUSION

Techniques for preferred network information are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
at least one processor; and
one or more computer-readable storage media including instructions stored thereon that, responsive to execution by the at least one processor, cause the system perform operations including:
receiving a query for network information, the query including a device location and a device type for a client device;
utilizing the device location and the device type to identify a preferred network for the device type from multiple networks that are associated with the location; and
communicating network information that identifies the preferred network for receipt by the client device to enable the client device to connect to the preferred network.

2. A system as recited in claim 1, wherein said query is received in response to initiation of a communication session involving the client device.

3. A system as recited in claim 1, wherein said the device type specifies one or more of a device manufacturer, a device model, or a device driver configuration.

4. A system as recited in claim 1, wherein said query comprises a database query by an entity that maintains the database.

5. A system as recited in claim 1, wherein the query further includes one or more media types, and wherein said utilizing further comprises utilizing the one or more media types to identify the preferred network.

6. A system as recited in claim 1, wherein said utilizing further comprises utilizing the device location and the device type to identify multiple preferred networks associated with the location including the preferred network, and wherein the network information identifies the multiple preferred networks.

7. A system as recited in claim 1, wherein said utilizing further comprises utilizing the device location and the device type to identify multiple preferred networks associated with the location including the preferred network, and wherein the network information identifies the multiple preferred networks as a ranked list of preferred networks.

8. A system as recited in claim 1, wherein the network information further identifies one or more preferred access points for the preferred network.

9. A system as recited in claim 1, wherein the operations further include:
receiving feedback regarding the preferred network; and
modifying network information for the preferred network based on the feedback.

10. A system as recited in claim 1, wherein the operations further include:
receiving negative feedback regarding a preferred network;
performing a verification action based on the negative feedback; and
updating network information for the preferred network based on a result of the verification action.

11. A computer-implemented method comprising:
receiving at a client device network information from a remote service, the network information identifying a preferred network for transmitting a specific media type from the client device and from multiple networks associated with a location of the client device; and
transmitting a signal over the preferred network that includes media data of the specific media type.

12. A method as recited in claim 11, wherein the media data is generated via an application that is executable at an application layer of the client device.

13. A method as recited in claim 11, further comprising querying for network information in response to initiation of a communication session, and wherein said receiving the network information occurs in response to said querying.

14. A method as recited in claim 11, further comprising querying for network information in response to initiation of a communication session, said querying including specifying a location of the client device and a device type of the client device, and wherein said receiving the network information occurs in response to said querying.

15. A method as recited in claim 11, wherein said transmitting the signal over the preferred network overrides a default connectivity behavior of the client device.

16. A method as recited in claim 11, further comprising:
querying for network information in response to ascertaining that the preferred network is available to perform a wireless handover of a communication session from a different network, the network information specifying that a quality of the preferred network is sufficient to allow the wireless handover; and
performing a wireless handover to the preferred network prior to transmitting the signal over the preferred network, the signal including media data of the communication session.

17. A method as recited in claim 11, further comprising:
generating feedback indicating a quality of a data stream received over the preferred network; and
communicating the feedback to the remote service.

18. A computer-implemented method comprising:
receiving feedback for a preferred network associated with a particular location and for a particular device type; and
modifying network information for the preferred network and for the particular device type based on the feedback.

19. A method as described in claim 18, wherein the feedback indicates a quality problem with the preferred network, and wherein said modifying comprises one or more of demoting the preferred network in a list of preferred networks, or removing the preferred network from the list of preferred networks.

20. A method as described in claim 18, wherein the feedback indicates a quality problem with the preferred network, and wherein the method further comprises:
performing a verification action based on the negative feedback; and
updating network information for the preferred network based on a result of the verification action.
